(19) United States
(12) Patent Application Publication
(10) Pub. No.: US 2025/0317292 A1
(43) Pub. Date: Oct. 9, 2025

(54) DATA PROCESSING DEVICE AND METHOD FOR OPERATING A DATA PROCESSING DEVICE

(71) Applicant: Robert Bosch GmbH, Stuttgart (DE)

(72) Inventors: Idris Kaya, Sindelfingen (DE); Eugen Becker, Ludwigsburg (DE); Franz Nottensteiner, Reutlingen (DE); Matthias Schreiber, Vaihingen/Enz (DE)

(21) Appl. No.: 19/171,590

(22) Filed: Apr. 7, 2025

(30) Foreign Application Priority Data
Apr. 9, 2024 (DE) 10 2024 203 190.9

(51) Int. Cl. H04L 9/32

(52) U.S. Cl. CPC H04L 9/32

(57) ABSTRACT

A data processing device for a control unit. The data processing device includes first and second computing units. The first computing unit includes a first memory device configured to provide first data to be sent, a first cryptography unit configured to encrypt the first data to be sent, and a first serial communication interface configured to send the first encrypted data to be sent from the first computing unit to the second computing unit. The second computing unit includes a second serial communication interface configured to receive the first, encrypted data from the first computing unit, a second cryptography unit configured to decrypt the first, received, encrypted data, and a second memory device configured to store the first, received, decrypted data.

### FIELD

The present invention relates to a data processing device, a control device and a method for operating a data processing device.

### BACKGROUND INFORMATION

Modern control units increasingly use two microcontrollers (μC) to provide the required computing power. In order to ensure smooth operation, communication between both controllers is required, which is carried out via the chip-to-chip interface (C2C). This interface offers high bandwidth and low latency. The CPU should be loaded as little as possible and is only used for preparing the data to be transmitted, initiating transmission and error management in the event of a transmission error. The data transmission itself is carried out autonomously, even for large data and is unencrypted. There is a risk here that the data stream can be intercepted and, in the worst case, tampered with.

### SUMMARY

Against this background, the present invention includes a data processing device, a control device, a method, a computer program, and a computer-readable medium.

According to an example embodiment of the present invention, the data processing device comprises at least a first computing unit and a second computing unit. The first computing unit is equipped with a first memory device, which is configured to provide first data to be sent. Furthermore, the first computing unit has a first cryptography unit, which is configured to encrypt the first data to be sent. A first, in particular serial, communication interface is also integrated in the first computing unit, in order to send the first encrypted data from the first computing unit to the second computing unit.

The second computing unit is equipped with a second, in particular serial, communication interface, in order to receive the first encrypted data from the first computing unit. Furthermore, the second computing unit has a second cryptography unit, which is configured to decrypt the first received, encrypted data. A second memory device is likewise integrated in the second computing unit to store the first received, decrypted data.

The data processing device is configured such that at least two of the following components—the first memory unit, the first cryptography unit, the first communication interface, the second memory unit, the second cryptography unit and the second communication interface—are configured to process the data at least partially in parallel.

According to an example embodiment of the present invention, the first cryptography unit and/or the second cryptography unit can be integrated as a special hardware component in the corresponding computing units or microcontrollers, which performs the encryption and decryption processes efficiently and quickly. This hardware component can support various encryption algorithms, such as AES (Advanced Encryption Standard).

Here, this takes advantage of the fact that (symmetric) encryption and decryption algorithms use a fixed block size (e.g., 128 bits in the case of AES) and, depending on the operating mode, encryption and decryption can be carried out block by block—without knowledge of the entire message (e.g., Galois/Counter Mode (GCM)).

In particular, the first cryptography unit and/or the second cryptography unit can be optimized to ensure a transmission speed of the C2C interface.

The first communication interface and/or the second communication interface can be designed, for example, as a serial communication interface, wherein both communication interfaces can also be regarded as a single communication interface due to their mutual dependence. In particular, the single communication interface can be designed as a chip-to-chip interface (C2C interface) with five lines. These five lines can be one clock line and two data lines per communication direction, wherein the clock is provided by one of the two computing units. The data lines are designed differentially and are used to transmit the user data.

The data processing device according to the present invention makes possible, on the one hand, a secure transmission of data between the two computing units, without the risk of the data being intercepted and/or modified during transmission. On the other hand, the memory device makes it possible for the received, decrypted data to be stored for further processing steps. Furthermore, the data processing device according to the present invention makes efficient and fast processing of the data possible, as a result of which the performance of the data processing device is improved. Furthermore, the use of dedicated cryptography units can ensure that encryption and/or decryption is carried out exclusively on these units and that no resources of other elements of the computing units, in particular the respective processors, have to be used for this purpose. This means that their computing power can be optimally used for other tasks. Thus, secure and efficient communication between different computing units is made possible. Due to the parallel processing of the data, the performance of the data processing device is optimized and fast transmission of the encrypted data is ensured.

Further advantages can be found in the disclosure herein.

According to one example embodiment of the present invention, the second memory device is configured to provide second data to be sent, the second cryptography unit is configured to encrypt the second data to be sent, and the second communication interface is configured to send the second, encrypted data to be sent from the second computing unit to the first computing unit. Furthermore, the first communication interface is configured to receive the second, encrypted data from the second computing unit, the first cryptography unit is configured to decrypt the second received encrypted data, and the first memory device is configured to store the second received decrypted data. This makes bidirectional communication between the computing units possible, wherein both computing units are able to encrypt, send, receive, decrypt and store data, in particular simultaneously. This ensures efficient and secure data transmission.

According to one example embodiment of the present invention, at least two of the first memory unit, the first cryptography unit and the first communication interface and/or at least two of the second memory unit, the second cryptography unit and the second communication interface are configured to process the corresponding data at least partially in parallel. In other words, for example, the first memory unit can still provide data, while the first cryptography unit is already encrypting the data, or the first cryptography unit can still encrypt data, while the first communication interface is already sending the data to the second communication interface of the second computing unit. Furthermore, this can be understood to mean that the second communication interface is still receiving data, while the second cryptography unit is already decrypting the data, or the second cryptography unit is still decrypting data, while the second memory device is already storing the already decrypted data.

Due to this parallel processing, improved efficiency and performance of the data processing device is achieved.

According to a further example embodiment of the present invention, the first computing unit comprises a first logic that is designed in particular as hardware. The first logic is configured to send the first encrypted data to be sent directly and in particular without temporary storage to the second computing unit by means of the first communication interface. Likewise, the first logic is able to decrypt the second received encrypted data directly and in particular without temporary storage by means of the first cryptography unit.

Alternatively or additionally, according to an example embodiment of the present invention, the second computing unit comprises a second logic, which is designed in particular as hardware. The second logic is configured so that it sends the second encrypted data to be transmitted directly, and in particular without intermediate storage, by means of the second communication interface to the first computing unit. Likewise, the second logic is able to decrypt the first received encrypted data directly, and in particular without temporary storage, by means of the second cryptography unit. Due to this direct transmission and decryption of the encrypted data without temporary storage, the efficiency and speed of the data processing device are further improved.

According to a further example embodiment of the present invention, the first cryptography unit and/or the second cryptography unit encrypt and/or decrypt the data block by block, in particular without knowledge of an entire message. Due to the block-by-block encryption and decryption of the data, increased security is ensured. The cryptography units can divide the data into smaller blocks and encrypt and decrypt them independently without knowing the entire message. This makes effective and secure processing of data possible. In addition, the block-by-block encryption and decryption offer the advantage of better scalability. The data processing device can easily handle different data sizes, since the cryptography units can divide the data into blocks and process them individually. This makes flexible adaptation to different application scenarios and data volumes possible.

Thus, the block-by-block encryption and decryption of data without knowledge of the entire message contributes to improving the security, scalability and flexibility of the data processing device.

According to a further example embodiment of the present invention, the first communication interface and/or the second communication interface send and/or receive the data packet by packet, in particular without knowledge of an entire message. Due to packet-by-packet sending and receiving of data, efficient and flexible communication is made possible. The communication interfaces can divide the data into smaller blocks and send and receive them independently of one another, without knowing the entire message. This makes optimized data transmission possible, regardless of its size.

In addition, packet-by-packet sending and receiving offers the advantage of improved error detection and correction. Due to the division of the data into blocks, errors in transmission can be more easily detected and corrected. This contributes to ensuring reliable and error-free communication.

Thus, the packet-by-packet transmission of data without knowledge of an entire message through the first and/or second communication interface contributes to improving the efficiency, flexibility and reliability of the data processing device.

According to a further example embodiment of the present invention, the first memory device is configured to store the first, unencrypted data to be sent and the second, received, decrypted data in different areas in the first memory device and/or the second memory device is configured to store the first, received, decrypted data and the second, unencrypted data to be sent in different areas in the second memory device. Due to this arrangement, efficient and orderly storage of data in separate areas is made possible, which further optimizes data processing and data exchange.

According to a further example embodiment of the present invention, the first cryptography unit comprises a first cryptography module and a second cryptography module. Alternatively or additionally, the second cryptography unit may comprise a third cryptography module and a fourth cryptography module. The first cryptography module and the third cryptography module are configured to encrypt the data to be sent. The second cryptography module and the fourth cryptography module, on the other hand, are designed to decrypt the data to be received.

This makes possible a secure data transmission between the first computing unit and the second computing unit through the use of cryptography units and cryptography modules. Due to the encryption of the data to be sent and the decryption of the data to be received, increased data security is ensured. In particular, this ensures the secure use of the method in full duplex mode.

The aforementioned advantages also apply correspondingly to a control device that comprises at least one data processing device according to one of the above-described embodiments of the present invention. Thus, the control unit is equipped with a data processing device that implements the described functions and features of the above-described embodiments. This data processing device makes possible an improved chip-to-chip interface in control units by integrating encryption, parallel processing and other described functions. Thus, the control unit benefits from the advantages of secure and efficient data processing as described herein.

The aforementioned advantages of the present invention also apply correspondingly to a method for operating a data processing device, in particular according to one of the above-described embodiments, in particular for a control device according to the above-described embodiment. The method comprises the following steps:
providing first data to be sent by means of a first memory device;
encrypting the first data to be sent by means of a first cryptography unit;
sending the first, encrypted data by means of a first, in particular serial, communication interface; and/or
receiving first, encrypted data by means of a second, in particular serial, communication interface;
decrypting the first, received, encrypted data by means of a second cryptography unit; along with
storing the first, received, decrypted data by means of a second memory device,
   wherein at least two of the aforementioned steps run at least partially in parallel or with temporal overlap.

This makes the efficient and fast processing of the data possible, since different sub-steps can be carried out simultaneously or with temporal overlap. As a result, the overall processing time is reduced and the performance of the data processing device is improved. Thus, the method contributes to the optimization of the chip-to-chip interface and data processing in control units.

According to a further example embodiment of the present invention, the method comprises the following steps:
providing second data to be sent by means of the second memory device;
encrypting the second data to be sent by means of the second cryptography unit;
sending the second, encrypted data by means of the second communication interface; and/or
receiving second, encrypted data by means of the first communication interface;
decrypting the second, received, encrypted data by means of the first cryptography unit; and
storing the second, received, decrypted data by means of the first memory device.

According to a further example embodiment of the present invention, at least two of the following steps
providing first data to be sent by means of a first memory device;
encrypting the first data to be sent by means of a first cryptography unit;
sending the first, encrypted data by means of a first, in particular serial, communication interface;
   run at least partially in parallel or with temporal overlap.

Alternatively or additionally, according to an example embodiment of the present invention at least two of the following steps
receiving first, encrypted data by means of a second, in particular serial, communication interface;
decrypting the first, received, encrypted data by means of a second cryptography unit;
storing the first, received, decrypted data by means of a second memory device
   run at least partially in parallel or with temporal overlap.

Alternatively or additionally, according to an example embodiment of the present invention, at least two of the following steps
providing second data to be sent by means of the second memory device;
encrypting the second data to be sent by means of the second cryptography unit;
sending the second, encrypted data by means of the second communication interface;
   run at least partially in parallel or with temporal overlap.

Alternatively or additionally, according to an example embodiment of the present invention, at least two of the following steps
receiving second, encrypted data by means of the first communication interface;
decrypting the second, received, encrypted data by means of the first cryptography unit; and
storing the second, received, decrypted data by means of the first memory device;
   run at least partially in parallel or with temporal overlap.

This parallel or temporally overlapping execution of the steps makes efficient and fast processing of the data possible. Due to the simultaneous or overlapping execution of multiple steps, bottlenecks in processing can be avoided and the overall performance of the data processing device can be improved.

According to a further embodiment of the present invention, the steps of encryption and sending, which are carried out on the first computing unit, and/or the steps of reception and decryption, which are executed on the second computing unit, are carried out directly, in particular without temporary storage, by means of a first logic, in particular designed as hardware, of the first computing unit and/or the steps of encryption and sending, which are carried out on the second computing unit, and/or the steps of reception and decryption, which are executed on the second computing unit, are carried out directly, in particular without temporary storage, by means of a second logic, in particular designed as hardware, of the second computing unit. The direct execution of the steps by means of specialized hardware logic ensures optimal performance and efficiency of the system. Due to the omission of intermediate storage, the data flow is not interrupted, which results in accelerated processing and improved overall performance.

According to a further embodiment of the present invention, the first cryptography unit and/or the second cryptography unit encrypt and/or decrypt the data block by block, in particular without knowledge of an entire message. Due to the use of this block-wise encryption and decryption, the cryptography units can divide the data into smaller units and process them separately. This makes parallel processing of data blocks possible, which leads to a significant improvement in processing speed. Furthermore, the flexibility of the data processing device is increased, since it is no longer necessary to know or consider the entire message in advance. This makes efficient, flexible and secure processing of data possible in the described method.

According to a further embodiment of the present invention, the first communication interface and/or the second communication interface send and/or receive the data packet by packet, in particular without knowledge of an entire message. Accordingly, the communication interfaces are able to transmit the data in blocks, without requiring precise knowledge of the entire message. This makes efficient and flexible transmission of data possible, regardless of their size. The packet-by-packet transmission ensures smooth and consistent transmission of data, as a result of which the reliability and integrity of the data processing device are improved.

According to a further embodiment of the present invention, the first memory device stores the first, unencrypted data to be sent and the second, received, decrypted data in different areas in the first memory device and/or the second memory device stores the first, received, decrypted data and the second, unencrypted data to be sent in different areas in the second memory device. This makes possible a clear separation between the unencrypted data to be sent and the decrypted data received. Due to the use of separate areas within the memory devices, the integrity and security of the data is ensured, since any mixing or overwriting of the data is avoided.

The aforementioned advantages also apply correspondingly to a computer program comprising instructions that, when the computer program is executed by a computer or by a data processing device according to one of the above-described exemplary embodiments of the present invention or by a control device according to a above-described exemplary embodiment of the present invention, cause the latter to carry out at least one of the steps of the method according to one of the above-described exemplary embodiments of the present invention.

The present invention also relates to a computer-readable medium on which the computer program is stored.

### BRIEF DESCRIPTION OF THE DRAWINGS

Exemplary embodiments of the present invention are illustrated schematically in the figures and explained in more detail in the following description. The same reference signs are used for the elements which are shown in the various figures and act similarly, and therefore a repeated description of the elements is dispensed with.

FIG. 1 is a schematic representation of a data processing device according to an exemplary embodiment of the present invention.

FIG. 2 is a schematic representation of a data processing device according to a further exemplary embodiment of the present invention.

FIG. 3 is a schematic representation of a method according to an embodiment example of the present invention.

### DETAILED DESCRIPTION OF EXAMPLE EMBODIMENT

As explained above, the present invention includes a data processing device, a method for operating a data processing device, a control unit, a computer program and a computer-readable medium, which make it possible to protect data transmission between two computing units against interception and/or tampering in a resource-saving manner.

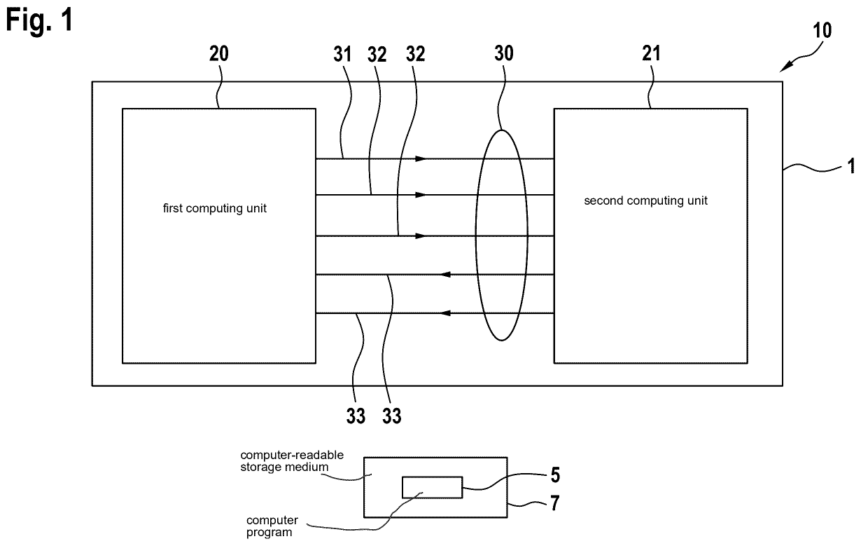

FIG. 1 illustrates, according to an exemplary embodiment of the present invention, a data processing device 10 that comprises a first computing unit 20 and a second computing unit 21. The computing units 20, 21 can be, for example, microcontrollers or microprocessors that are connected for signal or data purposes via a communication interface 30, for example via a chip-to-chip interface (C2C). The communication interface 30 comprises 5 lines: a clock line 31, which is provided by one of the two computing units 20, 21, along with two parallel data lines 32 from the first computing unit 20 to the second computing unit 21 and two parallel data lines 33 from the second computing unit 21 to the first computing unit 20. It can be provided here that a full duplex mode, i.e. the simultaneous transmission of data from the first computing unit 20 to the second computing unit 21 and of data from the second computing unit 21 to the first computing unit 20, is made possible. The data processing device 10 can, for example, be arranged on or in a control unit 1, in particular for a vehicle.

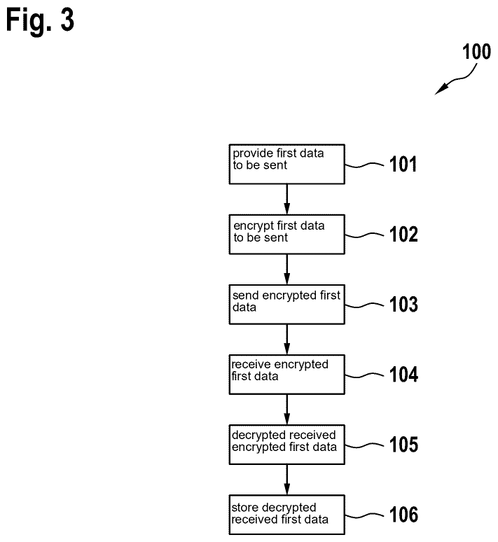

Furthermore, FIG. 1 shows a computer program 5 that is stored on a computer-readable storage medium 7 and, when executed by a computer or by the data processing device 10, causes the computer or the data processing device to carry out the steps of the method 100 according to FIG. 3.

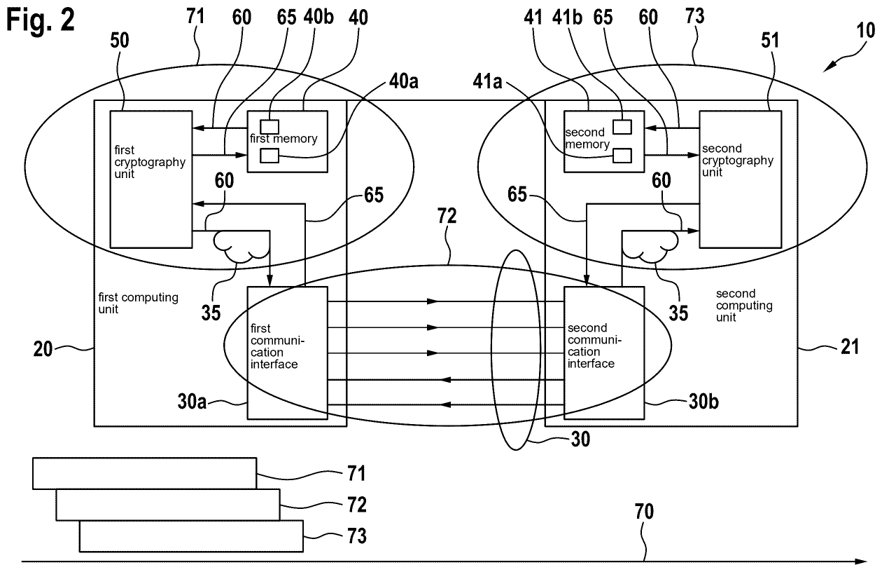

In FIG. 2, the data processing device 10 from FIG. 1 is shown again in more detail. Here, the individual components of the computing units 20, 21 are explained in more detail below. The first computing unit 20 has a first memory device 40, a first cryptography unit 50 and a first communication interface 30a. The second computing unit 21 has a second memory device 41, a second cryptography unit 51 and a second communication interface 30b. Here, the first communication interface 30a and the second communication interface 30b can be designed as a serial interface and/or can interact in such a way that they form the communication interface 30 as explained in FIG. 1.

The first memory device 40 is configured to provide the first cryptography unit 50 with first data 60 to be sent. The first cryptography unit 50 encrypts the first data 60 to be sent and forwards the first, encrypted data 60 to be sent to the first communication interface 30a, which sends the first, encrypted data 60 to be sent to the second communication interface 30b. For example, the transmission of the first data 60 can take place in specific data packets. For example, an entire message can be, for example, 1 kB and can be varied up or down depending on the latency requirement. Here, the individual steps, i.e. encryption, transmission and decryption, can take place at least partially in parallel or overlapped in time. In particular, it can be provided that, for example, the first memory unit 40 still provides data 60, while the first cryptography unit 50 is already encrypting the data 60, or the first cryptography unit 50 is still encrypting data 60, while the first communication interface 30a is already sending the data 60 to the second communication interface 30b of the second computing unit 21.

Preferably, the entire message can be divided into data packets whose size corresponds to a multiple of the encryption block size (for example, data packets of size 16 bytes or multiples in the case of AES). While the first data packets are being transmitted, data packets still to be transmitted are encrypted block by block and/or data packets already transmitted are already decrypted block by block.

The second communication interface 30b is configured to receive the first, encrypted data 60 and forward them to the second cryptography unit 51. The second cryptography unit 51 is configured to decrypt the first, received, encrypted data 60. The second memory device 41 is configured to store the first, received, decrypted data 60.

Here, the individual steps, i.e. reception, decryption and storage, can take place at least partially in parallel or overlapped in time. In particular, the second communication interface 30b can still receive data 60, while the second cryptography unit 51 is already decrypting the data 60, or the second cryptography unit 51 can still decrypt data 60, while the second memory device 41 is already storing the already decrypted data 60.

Alternatively or additionally, the second memory device 41 can be configured to provide the second cryptography unit 51 with second data 65 to be sent. The second cryptography unit 51 encrypts the second data 65 to be sent and forwards the second, encrypted data 65 to be sent to the second communication interface 30b, which sends the second, encrypted data 65 to be sent to the first communication interface 30a.

Here as well, the individual steps, i.e. encryption, transmission and decryption, can take place at least partially in parallel or overlapped in time.

Alternatively or additionally, the first communication interface 30a can be configured to receive the second, encrypted data 65 and to forward them to the first cryptography unit 50. The first cryptography unit 50 is configured to decrypt the second, encrypted data 65. The first memory device 40 is configured to store the second, received, decrypted data 65.

In particular, the individual steps, i.e. reception, decryption and storage, can take place here at least partially in parallel or overlapped in time.

Another advantage of this approach is the fact that no further software interaction is necessary after the start of an encrypted transmission. All necessary triggers and/or handshaking are carried out on the hardware side. If the encryption or decryption fails or the data 60, 65 are not transmitted to the cryptography units 50, 51 on a timely basis, this is signaled by error flags and further transmission is stopped.

The first computing unit 20 further comprises a first logic 35, in particular designed as hardware, wherein the first logic 35 is configured to send the first, encrypted, data 60 to be sent directly, in particular without temporary storage, to the second computing unit 21 by means of the first communication interface 30a and/or to decrypt the second, received, encrypted data 65 directly, in particular without temporary storage, by means of the first cryptography unit 50.

Alternatively or additionally, the second computing unit 21 comprises a second logic 36, in particular designed as hardware, wherein the second logic 36 is configured to send the second, encrypted data 65 to be sent directly, in particular without temporary storage, to the first computing unit 20 by means of the second communication interface 30b and/or to decrypt the first, received, encrypted data 60 directly, in particular without temporary storage, by means of the second cryptography unit 51.

Optionally, for this purpose, the first memory unit 40 can store or provide the first data 60 to be sent in a first area 40a, which is different from a second area 40b of the first memory unit 40, in which the second, received, decrypted data 65 are stored.

Furthermore, the second memory unit 41 can optionally store or provide the second data 65 to be sent in a first area 41a, which is different from a second area 41b of the second memory unit 41, in which the first, received, decrypted data 60 are stored.

The parallel nature of these processes is further illustrated based on the timeline 70 based on the first data 60 in FIG. 2. First, the process begins with an encryption 71 of the first data 60. While the encryption 71 is still taking place, a transmission 72 of the first data 60 is carried out from the first computing unit 20 to the second computing unit 21. And while the transmission 72 is still taking place, in particular while the encryption 71 is still taking place, a decryption 73 of the first data 60 is carried out.

FIG. 3 is a schematic representation of a method 100 according to an exemplary embodiment. Here, data 60 are sent from a first computing unit 20 to a second computing unit 21 and alternatively or additionally received by the latter. According to a first method step 101, providing the first data 60 to be sent can be carried out by means of a first memory device 40. According to a second method step 102, encrypting the first data 60 to be sent can be carried out by means of a first cryptography unit 50. According to a third method step 103, sending the first, encrypted data 60 can be carried out by means of a first communication interface 30a.

Alternatively or additionally, according to a fourth method step 104, receiving the first, encrypted data 60 can be carried out by means of a second, in particular serial, communication interface 30b. According to a fifth method step 105, decrypting the first, received, encrypted data 60 can be carried out by means of the second cryptography unit 51. According to a sixth method step 106, storing the first, received, decrypted data 60 can be carried out by means of the second memory device 41.

Alternatively or additionally, the method (not additionally shown) can also take place in the opposite direction, wherein data 65 are sent from the second computing unit 21 to the first computing unit 20 and alternatively or additionally received by the latter. In particular, sending the data 60 from the first computing unit 20 to the second computing unit 21 or receiving the data 60 by the second computing unit 21 along with sending the data 65 from the second computing unit 21 to the first computing unit 20 or receiving the data 65 by the first computing unit 20 can be carried out simultaneously or in full duplex mode. For this purpose, the first cryptography unit 50 can comprise a first cryptography module in order to encrypt the data 60 to be sent and a second cryptography module to decrypt the data 65 to be received, and the second cryptography unit can comprise a third cryptography module in order to encrypt the data 65 to be sent and a fourth cryptography module to decrypt the data 60 to be received.

According to the following steps (not shown), in the first method step, providing second data 65 to be sent can be carried out by means of the second memory device 41. According to a second method step, encrypting the second data 65 to be sent can be carried out by means of the second cryptography unit 51. According to a third method step, sending the second, encrypted data 65 can be carried out by means of the second, in particular serial, communication interface 30b.

Alternatively or additionally, according to a fourth method step, receiving the second, encrypted data 65 can be carried out by means of the first, in particular serial, communication interface 30a. According to a fifth method step, decrypting the second, received, encrypted data 65 can be carried out by means of the first cryptography unit 50. According to a sixth method step, storing the second, received, decrypted data 65 can be carried out by means of the first memory device 40.

1-18. (canceled)

19. A data processing device for a control device, comprising:
at least a first computing unit and a second computing unit;
wherein the first computing unit includes a first memory device configured to provide first data to be sent, a first cryptography unit configured to encrypt the first data to be sent, and a first serial communication interface configured to send the encrypted first data to be sent from the first computing unit to the second computing unit,
wherein the second computing unit includes a second serial communication interface configured to receive the encrypted first data from the first computing unit, a second cryptography unit that is configured to decrypt the received encrypted first data, and a second memory device configured to store the decrypted received first data,
wherein at least two of the following elements are configured to processess the first data at least partially in parallel:
the first memory unit, the first cryptography unit, the first communication interface, the second memory unit, the second cryptography unit, and the second communication interface.

20. The data processing device according to claim 19, wherein the second memory device is configured to provide second data to be sent, the second cryptography unit is configured to encrypt the second data to be sent, and the second communication interface is configured to send the encrypted second data to be sent from the second computing unit to the first computing unit, and the first communication interface is configured to receive the encrypted second data from the second computing unit, the first cryptography unit is configured to decrypt the received encrypted second data, and the first memory device is configured to store the decrypted received second data.

21. The data processing device according to claim 19, wherein: (i) at least two of the first memory unit, the first cryptography unit, and the first communication interface and/or (ii) at least two of the second memory unit, the second cryptography unit, and the second communication interface, are configured to process corresponding data at least partially in parallel.

22. The data processing device according to claim 20, wherein:
the first computing unit includes a hardware first logic, wherein the first logic is configured: (i) to send the encrypted first data to be sent directly, without temporary storage, using the first communication interface to the second computing unit and/or (ii) to decrypt the received encrypted second data directly, without temporary storage, using the first cryptography unit, and/or
that the second computing unit includes a hardware second logic, wherein the second logic is configured: (i) to send the encrypted second data to be sent directly, without temporary storage, using the second communication interface to the first computing unit, and/or (ii) to decrypt the received first encrypted data directly, without temporary storage, using the second cryptography unit.

23. The data processing device according to claim 19, wherein the first cryptography unit and/or the second cryptography unit, is configured to encrypt and/or decrypt data block by block, without knowledge of an entire message.

24. The data processing device according to claim 19, wherein the first communication interface and/or the second communication interface, is configured to send and/or receive data packet by packet, without knowledge of an entire message.

25. The data processing device according to claim 20, wherein the first memory device is configured to store the first data to be sent, unencryted, and the decryped received second data in different areas in the first memory device and/or the second memory device is configured to store the decrypted received first data and the second data to be sent, unencrypted, in different areas in the second memory device.

26. The data processing device according to claim 20, wherein the first cryptography unit includes a first cryptography module and a second cryptography module and/or the second cryptography unit includes a third cryptography module and a fourth cryptography module, wherein the first cryptography module and the third cryptography module are configured to encrypt data to be sent and the second cryptography module and the fourth cryptography module are configured to decrypt data received.

27. A control unit, comprising:
at least one data processing device including:
at least a first computing unit and a second computing unit;
wherein the first computing unit includes a first memory device configured to provide first data to be sent, a first cryptography unit configured to encrypt the first data to be sent, and a first serial communication interface configured to send the encrypted first data to be sent from the first computing unit to the second computing unit,
wherein the second computing unit includes a second serial communication interface configured to receive the encrypted first data from the first computing unit, a second cryptography unit that is configured to decrypt the received encrypted first data, and a second memory device configured to store the decrypted received first data,
wherein at least two of the following elements are configured to processess the first data at least partially in parallel:
the first memory unit, the first cryptography unit, the first communication interface, the second memory unit, the second cryptography unit, and the second communication interface.

28. A method for operating a data processing device for a control unit, the method comprising the following steps:
(i) performing:
providing first data to be sent using a first memory device,
encrypting the first data to be sent using a first cryptography unit, sending the encrypted first data using a first serial communication interface; and/or
(ii) performing:
receiving the encrypted first data using a second serial communication interface,
decrypting the received encrypted first data using a second cryptography unit, and
storing the decrypted received first data using a second memory device;
wherein at least two of the following steps run at least partially in parallel or with temporal overlap:
the providing, the encrypted, the sending, the receiving, the decrypteding, the storing.

29. The method according claim 28, further comprising:
(i) performing:
providing second data to be sent using the second memory device,
encrypting the second data to be sent using the second cryptography unit, and
sending the encrypted second data using the second communication interface and/or
(ii) performing:
receiving the encrypted second data using the first communication interface,
decrypting the received encrypted second data using the first cryptography unit, and
storing the decrypted received second data using the first memory device.

30. The method according to claim 28, wherein:
(i) at least two of the following steps run at least partially in parallel or with temporal overlap: the providing, the encryting, the sending, and/or
(ii) at least two of the following steps run at least partially in parallel or with temporal overlap: the receiving, the decrypting, the storing.

31. The method according to claim 29, wherein:
(i) at least two of the following steps run at least partially in parallel or with temporal overlap: the providing, the encryting, the sending, and/or
(ii) at least two of the following steps run at least partially in parallel or with temporal overlap: the receiving, the decrypting, the storing.

32. The method according to claim 28, wherein the receiving and the sending are carried out directly without temporary storage, using a hardware first logic of the first computing unit.

33. The method according to claim 29, wherein the receiving and the decrypting are carried out directly without temporary storage, using a hardware first logic of the first computing unit.

34. The method of claim 29, wherein the encrypting and sending are carried out directly, without temporary storage, using a hardware second logic of the second computing unit.

35. The method of claim 28, wherein the receiving and the decrypting are carried out directly, without temporary storage, using a hardware second logic of the second computing unit.

36. The method according to claim 28, wherein the first cryptography unit and/or the second cryptography unit encrypt and/or decrypt data block by block, without knowledge of an entire message.

37. The method according to claim 28, wherein the first communication interface and/or the second communication interface, send and/or receive data packet by packet without knowledge of an entire message.

38. The method according to claim 29, wherein the first memory device stores the first data to be sent, unencrypted, and the decrypted received second data in different areas in the first memory device and/or the second memory device stores the decrypted received first data and the second data to be sent, unencrypted, in different areas in the second memory device.

39. A non-transitory computer-readable medium on is stored a computer program for operating a data processing device for a control unit, the data processing device, when executed by the data processing device, causing the data processing device to perform the following steps:
(i) performing:
providing first data to be sent using a first memory device,
encrypting the first data to be sent using a first cryptography unit,
sending the encrypted first data using a first serial communication interface; and/or
(ii) performing:
receiving the encrypted first data using a second serial communication interface,
decrypting the received encrypted first data using a second cryptography unit, and
storing the decrypted received first data using a second memory device;
wherein at least two of the following steps run at least partially in parallel or with temporal overlap:
the providing, the encrypted, the sending, the receiving, the decrypteding, the storing.
